(19) United States
(12) Patent Application Publication
(10) Pub. No.: US 2025/0356437 A1
(43) Pub. Date: Nov. 20, 2025

(54) SYSTEMS AND METHODS FOR DETERMINING OR PREDICTING LOCALIZED CARBON INTENSITY OF ELECTRICAL GRIDS

(71) Applicant: Kevala, Inc., San Francisco, CA (US)

(72) Inventors: Robert CURRIE, Brooklyn, NY (US); Aram SHUMAVON, San Francisco, CA (US); Peter MALTBAEK, Mountain View, CA (US)

(21) Appl. No.: 19/065,317

(22) Filed: Feb. 27, 2025

Related U.S. Application Data
(63) Continuation of application No. PCT/US2023/072459, filed on Aug. 18, 2023.
(60) Provisional application No. 63/374,477, filed on Sep. 2, 2022.

(51) Int. Cl. G06Q 50/06; H02J 3/00; H02J 3/38

(52) U.S. Cl. CPC G06Q 50/06; H02J 3/003; H02J 3/004; H02J 3/381; H02J 2203/20

(57) ABSTRACT

Disclosed herein are systems and methods for predicting localized carbon intensity of an electrical grid, comprising: (a) receiving a topography of the electrical grid; and (b) assigning one or more emissions factors to a first set of nodes or a second set of nodes associated with one or more flows of electrical power through the first set of nodes or the second set of nodes of the topography. Assigning the one or more emissions factors may comprise using a trained machine learning (ML) model to determine a power distribution at a node of the first set of nodes or the second set of nodes. The trained ML model may be trained using one or more flows of electrical power through a first set of nodes or a second set of nodes of the topography. The method may also comprise (c) determining one or more carbon intensities from the one or more emissions factors at the first set of nodes or the second set of nodes, thereby predicting the localized carbon intensity of the electrical grid.

### CROSS-REFERENCE TO RELATED APPLICATIONS

This application is a continuation application of International Application No. PCT/US2023/072459, filed Aug. 18, 2023, which claims the benefit of U.S. Provisional Application No. 63/374,477, filed Sep. 2, 2022, each of which is incorporated by reference herein in its entirety.

### BACKGROUND

Climate change effects and efforts to achieve reduced carbon emissions have increased in importance. Climate change effects may include local and global temperature changes accompanied by more severe weather patterns. Decarbonizing the electricity sector, e.g., electrical grids, may be an important part of these efforts and may present a global challenge. Such efforts may be now prominent in policy and legislation in most of the world's leading economies. However, efforts to decarbonize the electricity sector may be primarily driven by governance at a local level instead of governance at a national or a federal level. Such a patchwork of policy and legislation may complicate finding uniform solutions that can achieve reduced carbon emissions. Further complicating efforts, behind-the-meter deployments of clean energy technologies e.g., distributed energy resources (DER), may make it difficult for policy makers and legislators to understand the actual impact of DER on carbon emissions. Methods that may provide more granular information about carbon emissions can provide a better framework for policy makers and legislators to achieve reduced carbon emissions. Granular information about carbon emissions may generally be referred to as localized carbon intensity (LCI) and supports a framework for total carbon accounting (TCA).

Localized carbon intensity may generally mean determining or predicting the geographic and temporal nature of carbon emissions across different scales of geography and time. A broad scope of localized carbon intensity may be associated with a large geographic market having many producers, transmission or distribution grids, suppliers, or consumers of electricity or a market where carbon emissions are measured over long periods of time. A narrow scope of localized carbon intensity may be associated with an individual producer, transmission or distribution grid, supplier, or consumer of electricity or where carbon emissions are measured over shorter periods of time. The scope of localized carbon intensity can be both broad and narrow. Also, localized carbon intensity methods recognize that accounting for carbon emissions at a granular level may require understanding the mix of different types of power generators associated with an electrical grid over long or short periods of time. An electrical grid may use a mix of power generators, for example, non-renewable, renewable, and distributed energy resources (DER). Each type of power generator may be associated with a different amount of carbon emissions.

Unfortunately, many methods for determining carbon emissions are flawed. Some of these methods may include market-based methods, location-based methods, or marginal emissions-based methods.

Market-based methods may determine carbon emissions from electricity purchased through public or private contracts. These contracts may provide emission factors (e.g., values relating quantities of carbon released into the atmosphere with activities or entities producing the carbon). Market-based methods may only be accurate if provided emission factors are unique to individual energy consumption e.g., emission factors correspond to actual power consumption. Further, responsibility for data quality control may rest on the reporting company. This may yield incomplete emissions data, especially when carbon emissions reporting is voluntary. Additionally, market-based methods may not identify locations having carbon intensities above or below the average carbon intensity for the market.

Location-based methods may determine emissions from electricity supplied via an electrical grid. Provided emission factors may represent average carbon emissions of the electrical grid over a geographic area or over a period of time. However, location-based methods may rely on public datasets that may be compiled for uses other than determining carbon emissions. Further, the scope of these datasets is broad because the datasets may describe carbon emissions over large geographic areas or over long periods of time. Marginal emissions-based methods may determine carbon emissions of an additional incremental unit of power demand based on a market dispatch of a specific power generator to provide the incremental unit of power demand. However, marginal emissions-based methods may not provide insight into the physical topographies of electrical grids and the actual electrical power flows between a location of the marginal generator unit, all other generator units, and a location of the increased unit of demand.

For at least these reasons, methods for determining and predicting LCI are needed to ascertain carbon emissions associated with all contributions to power flowing at any point and time within electrical grids or between electrical grids.

### SUMMARY

The present disclosure can address at least these issues, for example, by providing methods for determining or predicting localized carbon intensity at a specified geographic location of one or more electrical grids or between one or more electrical grids over a specified time period. Localized carbon intensity methods described herein support efforts to achieve reduced carbon emissions goals in electrical grids. Also, localized carbon intensity methods support a framework for policy makers and legislators to, for example, better plan and operate electricity sector infrastructure, design electrical rates, or implement programs to achieve reduced carbon emissions in electrical grids.

In an aspect, disclosed herein is a method for predicting localized carbon intensity of an electrical grid, comprising: (a) receiving a topography of said electrical grid; (b) assigning one or more emissions factors to a first set of nodes or a second set of nodes associated with one or more flows of electrical power through said first set of nodes or said second set of nodes of said topography, wherein said assigning comprises using a trained machine learning (ML) model to determine a power distribution at a node of said first set of nodes or said second set of nodes, wherein said trained ML model has been trained using one or more flows of electrical power through a first set of nodes or a second set of nodes of said topography; and (c) determining one or more carbon intensities from said one or more emissions factors at said first set of nodes or said second set of nodes, thereby predicting said localized carbon intensity of said electrical grid.

In some embodiments, the method further comprises, prior to said (b), generating said trained ML model. In some embodiments, said (a) or (c) is performed using one or more trained machine learning algorithms. In some embodiments, said (a) and (c) are performed using one or more trained machine learning algorithms. In some embodiments, said (a), (b), or (c) is performed using a cloud computing system. In some embodiments, said (a), (b), and (c) are performed using a cloud computing system.

In some embodiments, said receiving in (a) further comprises receiving one or more sets of data associated with said topography from one or more data sources.

In some embodiments, said one or more sets of data comprises data associated with a historical supply or a historical demand for said electrical power. In some embodiments, said historical supply or said historical demand is received before said predicting. In some embodiments, said historical supply or said historical demand is received at most about 1 year, 1 month, 1 week, 1 day, 1 hour, 1 minute, or less before said predicting. In some embodiments, said historical supply or said historical demand is received at least about 1 minute, 1 hour, 1 day, 1 week, 1 month, 1 year, or more before said predicting. In some embodiments, said historical supply or said historical demand is for a time period. In some embodiments, said time period is at most about 1 year, 1 month, 1 week, 1 day, 1 hour, 1 minute, or less. In some embodiments, said time period is at least about 1 minute, 1 hour, 1 day, 1 week, 1 month, 1 year, or more before.

In some embodiments, said one or more sets of data comprises data associated with power generators, power transmissions, power suppliers, or power consumers. In some embodiments, said one or more sets of data comprises data associated with a carbon intensity of one or more transmission nodes of said first set of nodes or of said second set of nodes. In some embodiments, said one or more sets of data comprises data associated with a carbon intensity of one or more sub-transmission nodes of said first set of nodes or of said second set of nodes. In some embodiments, said one or more sets of data comprises data associated with a carbon intensity of one or more primary feeder nodes of said first set of nodes or of said second set of nodes. In some embodiments, said one or more sets of data comprises data associated with a carbon intensity of one or more secondary feeder nodes of said first set of nodes or of said second set of nodes. In some embodiments, said one or more sets of data comprises data associated with a carbon intensity of one or more power consumer nodes of said first set of nodes or of said second set of nodes.

In some embodiments, said one or more sets of data comprises data associated with one or more seasonally adjusted parameters of said power generators, power suppliers, or power consumers. In some embodiments, said one or more seasonally adjusted parameters associated with said power generators comprises maximum power (Pmax), minimum power (Pmin), heat rates by unit, annual power production levels, or estimates of fuel costs.

In some embodiments, said one or more sets of data comprises data associated with distributed energy resources (DER). In some embodiments, said DER comprises non-renewable power or renewable power. In some embodiments, said DER comprises energy storage. In some embodiments, said energy storage comprises battery storage, thermal storage, mechanical storage, or pumped hydro storage.

In some embodiments, said one or more sets of data comprises one or more full sets of data or one or more partial sets of data, or both.

In some embodiments, said one or more data sources comprises one or more public data sources and one or more nonpublic data sources having said one or more sets of data. In some embodiments, said one or more data sources comprises one or more public data sources having said one or more sets of data. In some embodiments, said one or more data sources comprises one or more nonpublic data sources having said one or more sets of data.

In some embodiments, said trained ML model is trained by: (a) receiving one or more sets of data associated with said topography; (b) extracting a first set of linearized parameters from a first set of one or more flows of electrical power of said one or more sets of data; (c) generating a model from said first set of linearized parameters; (d) training said model by analyzing a second set of one or more flows of electrical power to obtain a second set of linearized parameters; and (e) updating said first set of linearized parameters with said second set of linearized parameters to thereby obtain said trained ML model.

In some embodiments, said first set of linearized parameters or said second set of linearized parameters are associated with one or more sensitivity factors. In some embodiments, said one or more sensitivity factors relate said one or more flows of electrical power at a first node of said first set of nodes to a second node at said second set of nodes. In some embodiments, said one or more sensitivity factors comprises a range of about 0 to about 1.

In some embodiments, said assigning in (b) further comprises: (a) receiving one or more sets of data associated with said topography having a first set of nodes and a second set of nodes; (b) associating one or more carbon intensities with one or more emissions factors of said first set of nodes or said second set of nodes from said one or more sets of data; and (c) allocating said one or more emissions factors to said first set of nodes or to said second set of nodes thereby assigning said emissions factors.

In some embodiments, said one or more emissions factors are associated with one or more non-renewable power generators or one or more renewable power generators. In some embodiments, said one or more emissions factors are associated with one or more non-renewable power generators. In some embodiments, said one or more emissions factors are associated with one or more renewable power generators.

In some embodiments, said determining in (c) further comprises: (a) determining a presence of one or more non-renewable power generators, renewable power generators, or distributed energy resources (DER) at said first set of nodes or at said second set of nodes; (b) using proportional sharing to determine one or more proportions of one or more carbon intensities of said presence of said non-renewable power generators, said renewable power generators, or said distributed energy resources (DER); and (c) allocating said one or more proportions to said first said of nodes or said second set of nodes thereby determining said one or more carbon intensities.

In some embodiments, said one or more flows of electrical power comprises a magnitude of said one or more flows of electrical power. In some embodiments, said magnitude is associated with one or more power losses in between said first of nodes and said second set of nodes. In some embodiments, said magnitude is associated with one or more voltage potentials between said first of nodes and said second set of nodes. In some embodiments, said magnitude comprises one or more current levels through said first of nodes and said second set of nodes. In some embodiments, said magnitude comprises one or more phase differences in said magnitude between said first set of nodes and said second set of nodes. In some embodiments, said magnitude comprises a real component or a reactive component or both. In some embodiments, said magnitude changes during a time period from a change in a supply of said electrical power or a change in a demand of said electrical power. In some embodiments, said magnitude changes during said time period from said change in said supply of electrical power. In some embodiments, said magnitude changes during said time period from said change in said demand of electrical power.

In some embodiments, said one or more flows of electrical power comprises a direction of said one or more flows of electrical power. In some embodiments, said direction comprises a direction between said first set of nodes and said second set of nodes. In some embodiments, said direction is associated with one or more power losses between said first of nodes and said second set of nodes.

In some embodiments, said localized carbon intensity comprises one or more temporal periods for predicting said localized carbon intensity. In some embodiments, said one or more temporal periods is associated with one or more changes in said topography. In some embodiments, said one or more changes comprises a change in one or more supplies of power or one or more demands for power during said one or more temporal periods. In some embodiments, said one or more changes comprises a change from using one or more renewable power generators to using one or more non-renewable power generators during said one or more temporal periods. In some embodiments, said one or more changes comprises a change from using one or more non-renewable power generators to using one or more renewable power generators during said one or more temporal periods. In some embodiments, said one or more changes comprises a change in a number of non-renewable power generators during said one or more temporal periods. In some embodiments, said one or more changes comprises a change in a number of renewable power generators during said one or more temporal periods. In some embodiments, said one or more temporal periods comprises at most about 1 year, 1 month, 1 week, 1 day, 1 hour, 1 minute, or less. In some embodiments, said temporal period comprises at least about 1 minute, 1 hour, 1 day, 1 week, 1 month, 1 year, or more.

In some embodiments, said localized carbon intensity comprises one or more geographic areas for predicting said localized carbon intensity. In some embodiments, said one or more geographic areas are associated with one or more market areas. In some embodiments, said one or more geographic areas are associated with one or more submarket areas. In some embodiments, said one or more geographic areas associated with one or more producers of said electrical power, one or more purchasers of said electrical power, or one or more consumers of said electrical power. In some embodiments, said one or more geographic areas are located within or outside of one or more market areas. In some embodiments, said one or more geographic areas are located within said one or more market areas. In some embodiments, said one or more geographics areas are located outside of said one or more market areas.

In some embodiments, said topography comprises one or more power generators. In some embodiments, said one or more power generators are associated with said first set of nodes or said second set of nodes. In some embodiments, said one or more power generators are associated with one or more carbon emission sources. In some embodiments, said localized carbon intensity is associated with said one or more carbon emission sources. In some embodiments, said one or more carbon emission sources comprises a quantity of carbon dioxide (CO₂) emitted per megawatt-hour (MWh) produced by said one or more power generators (kg CO₂ eq per MWh).

In some embodiments, said one or more power generators comprises one or more non-renewable power generators or one or more renewable power generators. In some embodiments, said one or more non-renewable power generators comprises a coal power generator, a gas power generator, or a nuclear power generator. In some embodiments, said one or more renewable power generators comprises a solar power generator, a solar mirror power generator, a wind power generator, a hydropower generator, a geothermal power generator, or a biomass power generator.

In some embodiments, said one or more power generators comprises one or more distributed energy resources (DER). In some embodiments, said one or more DER comprises one or more local power generators configured for local use. In some embodiments, said one or more local power generators comprises one or more of a roof top solar power, wind power, battery storage power, combined heat and power, biomass power, open and closed cycle gas turbine power, reciprocating engine power, hydro power, fuel cell power, or other generator types. In some embodiments, said one or more DER comprises one or more local energy storage devices configured for local use. In some embodiments, said one or more local energy storage devices comprises one or more battery storage devices, thermal storage devices, or mechanical storage devices. In some embodiments, said one or more DER comprises connecting or disconnecting to said electrical grid. In some embodiments, said connecting or disconnecting is based at least on said one or more flows of electrical power.

In some embodiments, said topography comprise one or more power transmissions. In some embodiments, said topography comprises one or more power suppliers. In some embodiments, said one or more power suppliers comprises one or more power purchase agreements (PPA), one or more private utility companies, one or more public utility companies, one or more cooperatives, one or more aggregators, one or more energy suppliers, or one or more energy service companies.

In some embodiments, said topography comprises one or more power consumers. In some embodiments, said one or more power consumers are associated with said first set of nodes or said second set of nodes. In some embodiments, said one or more power consumers comprises one or more of an industrial user, a commercial user, a corporate user, a data center user, or a residential user.

In some embodiments, said method further comprises: (a) receiving one or more reports of actual supply or actual demand of said one or more flows of electrical power; (b) using said one or more reports to determine one or more actual localized carbon intensities; (c) comparing said actual localized carbon intensities with one or more predicted localized carbon intensities; and (d) determining a new set of sensitivity parameters for predicting said localized carbon intensity.

In some embodiments, said method further comprises providing one or more reports to one or more stakeholders associated with said electrical grid. In some embodiments, said one or more reports comprises information associated with localized carbon intensity of said one or more stakeholders. In some embodiments, said one or more reports comprises one or more recommendations to reduce said localized carbon intensity of said one or more stakeholders. In some embodiments, said one or more reports comprises sharing said one or more reports with other said one or more stakeholders within said electrical grid. In some embodiments, said one or more reports comprises sharing said one or more reports with other said one or more stakeholders not within said electrical grid.

In some embodiments, said method reduces error in predicting said localized carbon intensity compared to other methods. In some embodiments, said other methods average carbon intensities. In some embodiments, said other methods average carbon intensities over a whole market area. In some embodiments, said other methods average carbon intensities over one or more submarkets of a whole market area. In some embodiments, said other methods use marginal carbon emissions.

In another aspect, disclosed herein is a method for generating a topography of an electrical grid, comprising: (a) receiving data associated with a plurality of components of said electrical grid; (b) determining one or more connections between two or more components of said plurality of components of said electrical grid; (c) associating said one or more connections with a first set of nodes or a second set of nodes of said electrical grid; and (d) determining one or more sensitivity factors between said first of nodes or said second set nodes, thereby generating said topography of said electrical grid.

In some embodiments, said data comprises data associated with power generators, power transmissions, power suppliers, or power consumers. In some embodiments, said data comprises geographic information system (GIS) data associated with said power generators, power transmissions, power suppliers, or power consumers.

In some embodiments, said receiving in (a) further comprises receiving said data from one or more data sources. In some embodiments, said one or more data sources comprises one or more public data sources or one or more private data sources.

In some embodiments, said one or more data sources comprises one or more satellite sources associated with satellite imagery. In some embodiments, said satellite imagery comprises visible imagery, infrared imagery, or water vapor imagery.

In some embodiments, said one or more data sources comprises one or more terrestrial sources associated with terrestrial imagery. In some embodiments, said terrestrial imagery comprises imagery from driving, pedaling, sailing, or walking around.

In some embodiments, said determining in (b) further comprises processing said data to determine said one or more connections.

In some embodiments, said associating in (c) further comprises identifying said one or more connections that are proximate to said first set of nodes or said second set of nodes.

In some embodiments, said determining in (d) further comprises generating one or more linearized parameters that are associated with said one or more sensitivity factors.

In another aspect, disclosed herein is a system for predicting localized carbon intensity of an electrical grid, comprising: one or more memory devices with computer-readable program code stored thereon; and one or more processing devices operatively coupled to the one or more memory devices, wherein the one or more processing devices are configured to execute the computer-readable program code to: (a) receive a topography of the electrical grid; (b) assign one or more emissions factors to a first set of nodes or a second set of nodes associated with one or more flows of electrical power through the first set of nodes or the second set of nodes of the topography, wherein the assigning comprises using a trained machine learning (ML) model to determine a power distribution at a node of the first set of nodes or the second set of nodes, wherein the trained ML model has been trained using one or more flows of electrical power through a first set of nodes or a second set of nodes of the topography; and (c) determine one or more carbon intensities from the one or more emissions factors at the first set of nodes or the second set of nodes, thereby predicting the localized carbon intensity of the electrical grid.

In another aspect, disclosed herein is a computer program product for predicting localized carbon intensity of an electrical grid, the computer program product comprising at least one non-transitory computer-readable medium having computer-readable program code portions embodied therein, the computer-readable program code portions comprising: an executable portion configured to receive a topography of the electrical grid; an executable portion configured to assign one or more emissions factors to a first set of nodes or a second set of nodes associated with one or more flows of electrical power through the first set of nodes or the second set of nodes of the topography, wherein the assigning comprises using a trained machine learning (ML) model to determine a power distribution at a node of the first set of nodes or the second set of nodes, wherein the trained ML model has been trained using one or more flows of electrical power through a first set of nodes or a second set of nodes of the topography; and an executable portion configured determine to one or more carbon intensities from the one or more emissions factors at the first set of nodes or the second set of nodes, thereby predicting the localized carbon intensity of the electrical grid.

Additional aspects and advantages of the present disclosure will become readily apparent from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 depicts an example of averaging carbon intensity over a market area;

FIG. 2 depicts an example of averaging carbon intensity within submarkets of a market area;

FIG. 3 depicts an example of localized carbon intensity within submarkets of a market area using methods described herein;

FIG. 4 depicts an example of localized carbon intensity compared to average carbon intensity of a market area or to average carbon intensity within submarkets of a market area using methods described herein;

FIG. 5 depicts a non-limiting example of a computing device configured to perform methods described herein;

FIG. 6 depicts a non-limiting example of a web or mobile application provision system configured to perform methods described herein;

FIG. 7 depicts a non-limiting example of a cloud-based web/mobile application provision system configured to perform methods described herein; and

FIG. 8 depicts an example workflow for generating or predicting localized carbon intensity.

### DETAILED DESCRIPTION

While various embodiments of the invention have been shown and described herein, such embodiments are provided by way of example only. Numerous variations, changes, and substitutions may occur without departing from the invention. It should be understood that various alternatives to the embodiments of the invention described herein may be employed.

Demand for electricity is increasing globally and is outpacing growth in renewable energy availability. This increase in demand may strain electrical grids, which in turn may cause them to rely more on non-renewable energy sources (e.g., fossil fuels) to meet demand, further causing emissions to increase.

Total carbon accounting (TCA) may generally refer to a framework for accounting for all carbon emissions. Accounting for all carbon emissions may require identifying, within one or more electrical grids, where electrical power is generated, supplied, and consumed. Further, TCA may provide a framework for identifying electrical power generation, electrical power supply, or electrical power consumption between one or more electrical grids. Additionally, TCA may provide a framework for quantifying carbon emissions of all electrical power generation, electrical power supply, and electrical power consumption over one or more periods of time. The TCA framework may focus on physical flows of electricity within one or more electrical grids or between one or more electrical grids. A focus on physical flows of electricity can support improved, granular reporting of carbon emissions. Improved reporting of carbon emissions may enable policy makers and legislators to better plan and operate electricity grid infrastructure to achieve reduced carbon emissions.

The TCA framework may use different methods to determine carbon emissions of an electrical grid. Some methods, as summarized in Table 1, may include market-based methods, location-based methods, or marginal emissions-based methods. Market-based methods may determine carbon emissions from electricity purchased through public or private contracts. Provided emission factors may be derived from these contracts. However, market-based methods may only be accurate if provided emission factors are unique to individual energy consumption. Location-based methods may determine emissions from electricity supplied via an electrical grid. Provided emission factors may represent average carbon emissions of the electrical grid over a geographic area or over a period of time. However, location-based methods rely on public datasets that may be compiled for uses other than determining carbon emissions. Further, the scope of these datasets is broad because the datasets may describe carbon emissions over large geographic areas and over long periods of time. Marginal emissions-based methods may determine carbon emissions of an additional incremental unit of power demand based on a market dispatch of a specific power generator to provide the incremental unit of power demand. However, marginal emissions-based methods may not provide insight into the physical topographies of electrical grids and the actual electrical power flows between a location of the marginal generator unit and a location of the increased unit of demand. Additionally, market-based methods may not identify locations having carbon intensities above or below the average carbon intensity for the market.

TABLE 1

| Scope 2¹ Reporting | | |
|---|---|---|
| Approaches | Market-Based Methods | Location-Based Methods |
| Definition | A method to quantify the | A method to quantify Scope 2 |
| | Scope 2 GHG emissions of a | GHG emissions based on |
| | reporter based on GHG | average energy generation |
| | emissions emitted by the | emission factors for defined |
| | generators from which the | geographic locations |
| | reporter contractually | including local, subnational, |
| | purchases electricity bundled | or national boundaries. |
| | with contractual instruments, | |
| | or contractual instruments on | |
| | their own. | |
| How the method allocates | Emission factors derived from | Emission factors representing |
| emissions | the GHG emission rate | average emissions from |
| | represented in the contractual | energy generation occurring |
| | instruments that meet Scope 2 | within a defined geographic |
| | Quality Criteria. | area and a defined time |
| | | period. |
| Where the method applies | To any operations in markets | To all electricity grids. |
| | providing consumer choice of | |
| | differentiated electricity | |
| | products or supplier-specific | |
| | data, in the form of | |
| | contractual instruments. | |
| Useful for showing | Individual corporate | GHG intensity of grids |
| | procurement actions. | where operations occur, |
| | Opportunities to influence | regardless of market type. |
| | electricity suppliers and | The aggregate GHG |
| | supply. | performance of energy |
| | Risks/opportunities | intensive sectors (for |
| | conveyed by contractual | example, comparing electric |
| | relationships, including | train transportation with |
| | sometimes legally enforceable | gasoline or diesel vehicle |
| | claims rules. | transit). |
| | | Risks/opportunities aligned |
| | | with local grid resources and |
| | | emissions. |
| What the method's results | Average emissions in the | Emissions from differentiated |
| omit | location where electricity use | electricity purchases or |
| | occurs. | supplier offerings, or other |
| | | contracts. |

Note¹
Scope 2 Guidance under the Greenhouse Gas Protocol (GHGP) prescribes a way to calculate carbon emissions associated with electricity consumption from sources owned or controlled by another organization.

Compared to localized carbon intensity methods described herein, these methods may not provide for the full scope of carbon emissions from electrical power generation, electrical power supply, and electrical power consumption in one or more electrical grids or between one or more electrical grids. Scope may include at least, for example, a geographic scope and a temporal scope of electrical power generation, electrical power supply, and electrical power consumption. A broad scope may be associated with a large geographic market having many producers, suppliers, or consumers of electricity or a market where carbon emissions are measured over long periods of time. A narrow scope may be associated with an individual producer, supplier, or consumer of electricity or where carbon emissions are measured over shorter periods of time. The scope of localized carbon intensity can be both broad and narrow.

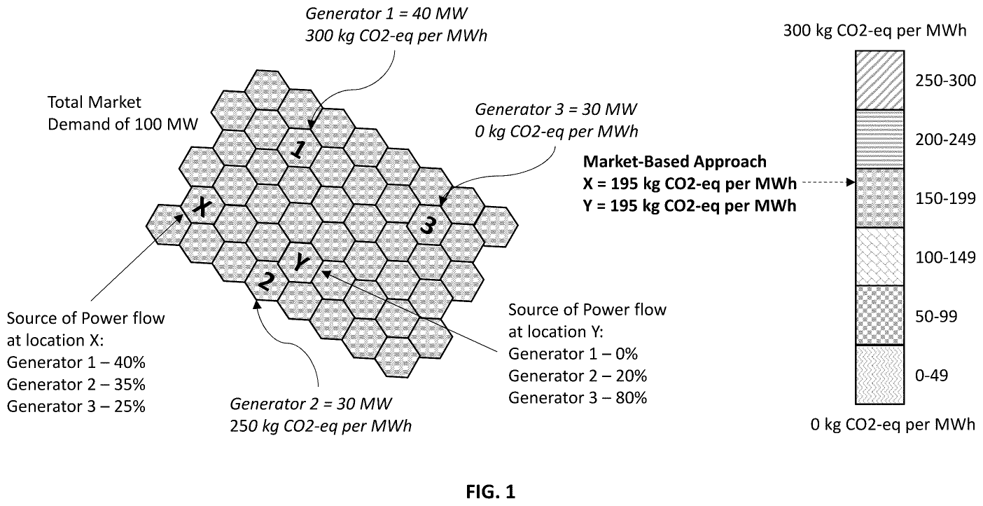

In an example, FIG. 1 illustrates some of the deficiencies associated with market-based approaches that may report an average carbon intensity for a market area by averaging carbon intensity over the entire market. The market may occupy a geographic area with uniform carbon intensity and may assume that every location within the market has the same carbon intensity. Locations X and Y may receive electrical power from a mix of power generator sources 1, 2, or 3. Location X may receive 75% of its power from generators 1 and 2, which are considered non-renewable and produce carbon emissions. Location Y may receive 80% of its power from generator 3, which is considered renewable and produces no carbon emissions. However, using market-based methods, both locations X and Y may report having the same carbon intensity using the average of the entire market. This average may be calculated as shown below and results in an average of 195 kilograms (kg) of carbon dioxide (CO₂) equivalent per megawatt-hour (MWh) over a 1 hour period. Market-based approaches may not capture the locational or temporal aspects of individual locations within the market and so fail to capture the realities of carbon emissions for those locations connected close to and using power from non-renewable power sources.

$$\frac{( ( 40 \times 300 ) + ( 30 \times 250 ) + ( 30 \times 0 ) )}{100} = 195 kg {CO}_{2} eq per MWh$$

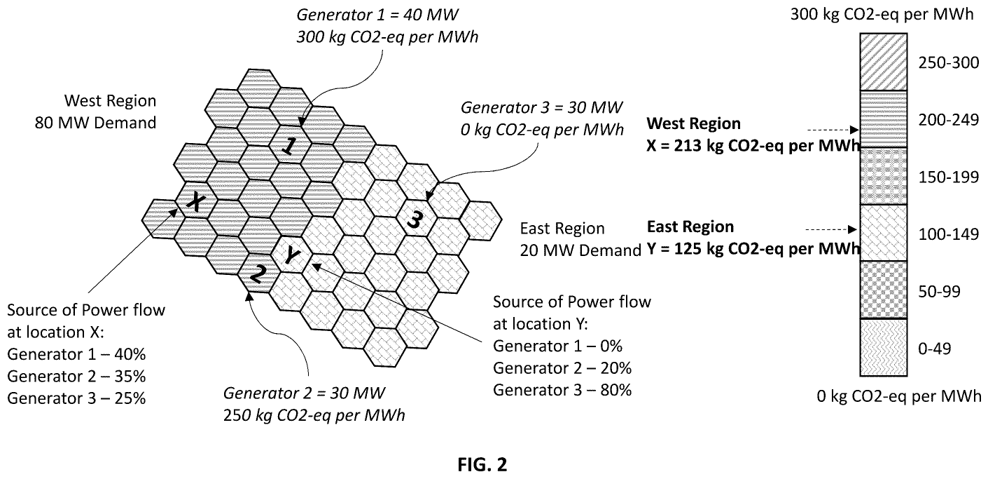

In an example, FIG. 2 illustrates some of the deficiencies associated with location-based approaches. Locational-based approaches e.g., regional carbon intensity approaches may seek alignment between a point of power generation and a point of power consumption. This approach may partition a market into regions or submarkets and so may report a carbon intensity for each region instead of reporting an average of the entire market.

As illustrated in FIG. 2, both regions or submarkets may be part of the same market. However, power generation in each region, East and West, and the flow of electrical power between them is used to define their respective carbon intensity values. The East Region may require 20 MW of electrical power over a 1 hour period. Its demand may be met by, for example, 10 MW from generator 2, a non-renewable source, and 10 MW from generator 3, a renewable source. The average carbon intensity of the East Region may be calculated as shown below and may result in an average of 125 kg CO₂ equivalent per MWh. This average may be applied to all locations in the East Region including location Y which may actually use a different mix of non-renewable and renewable sources.

$$\frac{( ( 0 \times 300 ) + ( 10 \times 250 ) + ( 10 \times 0 ) )}{20} = 125 kg {CO}_{2} eq per MWh$$

As further illustrated in FIG. 2, the West Region may require 80 MW of electrical power over a 1 hour period. Its demand may be met by, for example, 40 MW from generator 1, a non-renewable source, 20 MW from generator 2, a non-renewable source, and 20 MW from generator 3, a renewable source. The average carbon intensity of the West Region may be calculated as shown below and results in an average of 212 kg CO₂ equivalent per MWh. This average is applied to all locations in the West Region including location X which may use a different mix of non-renewable and renewable. Location-based approaches with individual locations within submarkets may have different carbon intensities than the average of the respective submarket based on the location's actual mix of non-renewable and renewable energy sources.

$$\frac{( ( 40 \times 300 ) + ( 20 \times 250 ) + ( 20 \times 0 ) )}{80} = 212 kg {CO}_{2} eq per MWh$$

Recognized herein is a need for methods for determining or predicting localized carbon intensity that can account for carbon emissions associated with all contributions to power generation, power supply, and power consumption at any location or time within one or more electrical grids or between one or more electrical grids. Discrete analysis of all electrical grid components associated with power generation, power transmission and distribution, power supply, and power consumption in a balance of power supply and demand may improve carbon awareness efforts to achieve reduced carbon emissions.

### Determining or Predicting Localized Carbon Intensity

In an aspect, disclosed herein is a method for predicting localized carbon intensity of an electrical grid, comprising: (a) receiving a topography of said electrical grid; (b) assigning one or more emissions factors to a first set of nodes or a second set of nodes associated with one or more flows of electrical power through said first set of nodes or said second set of nodes of said topography, wherein said assigning comprises using a trained machine learning (ML) model to determine a power distribution at a node of said first set of nodes or said second set of nodes, wherein said trained ML model has been trained using one or more flows of electrical power through a first set of nodes or a second set of nodes of said topography; and (c) determining one or more carbon intensities from said one or more emissions factors at said first set of nodes or said second set of nodes, thereby predicting said localized carbon intensity of said electrical grid.

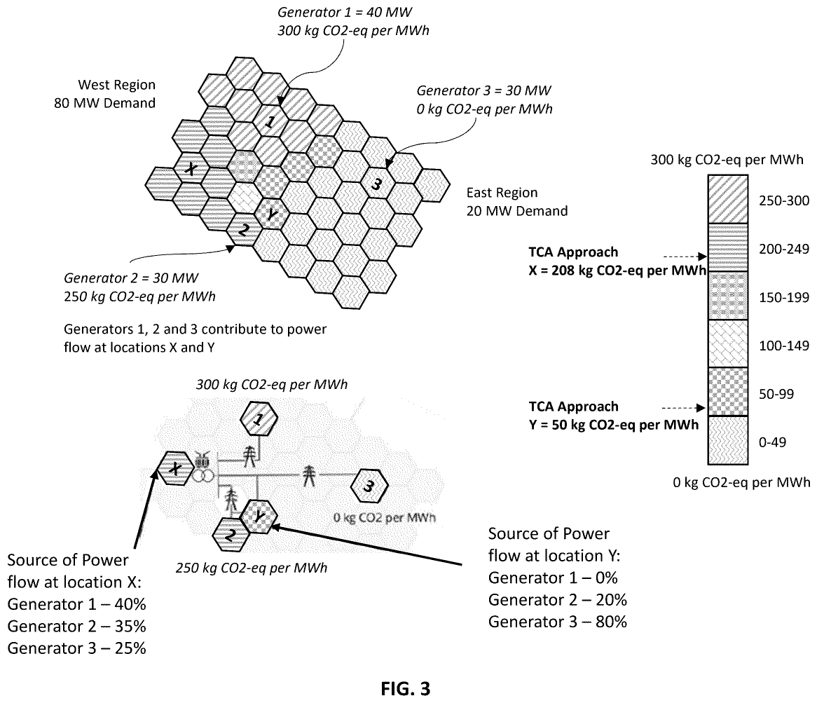

In an example, FIG. 3 illustrates total carbon accounting (TCA) provided by localized carbon intensity methods described herein. Compared to other methods such as market-based approaches, location-based approaches, or marginal emissions-based approaches, localized carbon intensity methods described herein may recognize that individual locations within a market may have a different mix of non-renewable and renewable sources affecting carbon intensity. As illustrated in FIG. 3, a market may be divided into two regions, East and West. The West Region may have a total demand of 80 MW over a 1 hour period. The West Region may include location X that meets its power demand through 40% of power supplied by generator 1, a non-renewable source, through 35% of power supplied by generator 2, a non-renewable source, and through 25% of power supplied by generator 3, a renewable source. The East Region may have a total demand of 20 MW over a 1 hour period. The East Region may include location Y that meets its power demand through 20% of power supplied by generator 2, a non-renewable source, and through 80% of power supplied by generator 3, a renewable source.

As further illustrated in FIG. 3, the carbon intensities of locations X and Y may be calculated as shown below and result in a carbon intensity of 208 kg CO₂ equivalent per MWh for location X and 50 CO₂ equivalent per MWh for location Y.

$$\begin{matrix}( 0.4 0 \times 300 ) + ( 0.35 \times 250 ) + ( 0.25 \times 0 ) = 208 kg {CO}_{2} eq per MWh \\ ( 0 \times 300 ) + ( 0.20 \times 250 ) + ( 0.80 \times 0 ) = 50 kg {CO}_{2} eq per MWh\end{matrix}$$

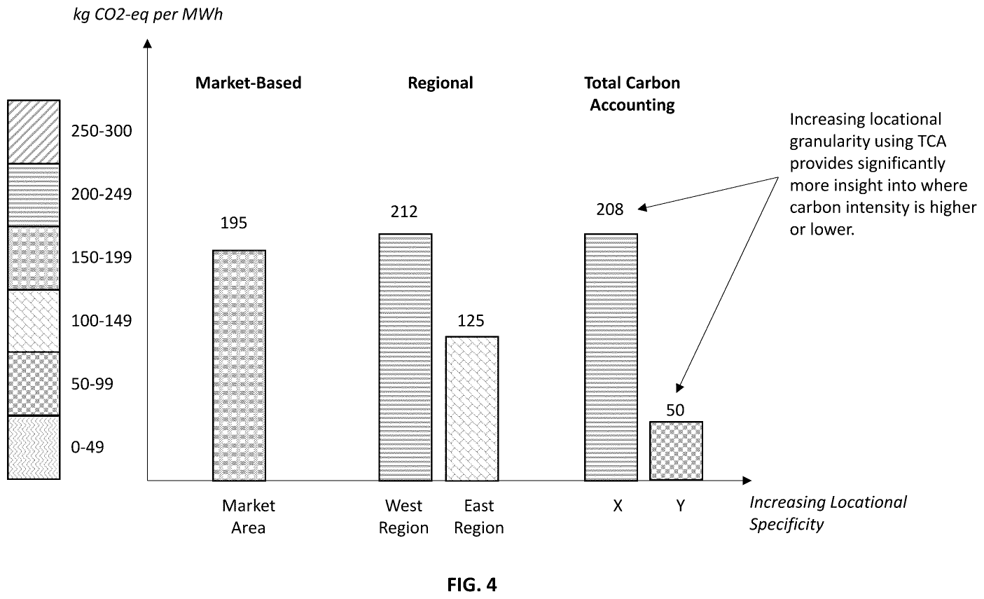

FIG. 4 illustrates an improvement of localized carbon intensity methods compared to other methods e.g., better accuracy of reported carbon intensity. For example, as shown previously using market-based approaches, both locations X and Y may report a carbon intensity of 195 kg CO₂ equivalent per MWh, which is the average of the entire market. Using location-based methods, locations X and Y would be reported to have carbon intensities of 212 kg CO₂ and 125 kg CO₂ equivalent per MWh, respectively, which is the average carbon intensity of each region or submarket.

As further illustrated in FIG. 4, localized carbon intensity methods may be more accurate compared to market-based approaches, location-based approaches, or marginal emissions-based approaches. For example, when comparing the market-based average of 195 kg CO₂ equivalent per MWh to the location-based averages, the West Region shows an increase in carbon intensity to 212 kg CO₂ equivalent per MWh while the East Region shows a reduction to 125 kg CO₂ equivalent per MWh. However, by considering the actual contributions or mix of the power generators to the loads, localized carbon intensity methods described herein identify that location X has an actual carbon intensity of 208 kg CO₂ equivalent per MWh. This carbon intensity is higher than the market-based average of 195 kg CO₂ equivalent per MWh (6.3% error) and similar to the location-based average for the West Region value of 212 kg CO₂ equivalent per MWh (1.9% error). Further, using localized carbon intensity methods described herein, location Y has an actual carbon intensity of 50 kg CO₂ equivalent per MWh. This carbon intensity is significantly lower than both the market-based average of 195 kg CO₂ equivalent per MWh (290% error) and the location-based average for the East Region of 125 kg CO₂ equivalent per MWh (150% error). Other locations within both regions or submarkets will also have different carbon intensities that can vary significantly from the market average or regional average based on actual contributions or mix of power from non-renewable and renewable sources.

Localized carbon intensity methods described herein may use or generate topographies of electrical grids. A topography of an electrical grid generally refers to the interconnected nature or network of power generation, power transmission and distribution, power supply, or power consumption. A complete understanding of the topography of an electrical grid may provide more accurate determining or reporting of carbon intensities. However, a partial or incomplete understanding of the topography of an electrical grid may introduce error in determining and reporting carbon intensities. In this sense, the topography may be viewed as a sparse data set. Methods described herein may use public or private data sets for the topography to determine or predict localized carbon intensity. Alternatively or additionally, methods described herein may generate the topography of an electrical grid to determine or predict localized carbon intensity.

In some embodiments, the receiving in (a) further comprises receiving one or more sets of data associated with the topography from one or more data sources. In an example, data sets may be associated with a historical supply of or a demand for power. Having some knowledge of historical supply of or demand for power will aid in determining or predicting localized carbon intensity of electrical grids. In some embodiments, the one or more sets of data comprises data associated with a historical supply or a historical demand for the electrical power. In some embodiments, the historical supply or the historical demand is received before the predicting. In an example, historical supply or demand may be used, in part, to initialize the determining or predicting of localized carbon intensity. Historical supply or demand may not be readily available and so historical supply or demand from a period occurring longer in the past e.g., 1 year in the past may be used for determining or predicting localized carbon intensity. Alternatively, historical supply or demand may be readily available and so historical supply or demand from a period occurring more recently e.g., 1 second in the past may be used for determining or predicting localized carbon intensity. In some embodiments, the historical supply or the historical demand is received at most about 1 year, 1 month, 1 week, 1 day, 1 hour, 1 minute, or less before the predicting. In some embodiments, the historical supply or the historical demand is received at least about 1 minute, 1 hour, 1 day, 1 week, 1 month, 1 year, or more before the predicting. In some embodiments, the historical supply or the historical demand is for a time period. In an example, historical supply or demand may show insubstantial variation over long time periods and so longer time periods e.g., 1 year may be used for determining or predicting localized carbon intensity. Alternatively, historical supply or demand may show substantial variation over long time periods and so shorter time periods e.g., 1 second may be used for determining or predicting localized carbon intensity. In some embodiments, the time period is at most about 1 year, 1 month, 1 week, 1 day, 1 hour, 1 minute, or less. In some embodiments, the time period is at least about 1 minute, 1 hour, 1 day, 1 week, 1 month, 1 year, or more before.

In some embodiments, the one or more sets of data comprises data associated with power generators, power transmissions, power suppliers, or power consumers. Power transmissions may include, for example, transmission and distribution grids. In an example, data sets may be associated with interconnected components associated with a topography of an electrical grid. Interconnected components may be viewed as the many interconnected nodes of the topography of the electrical grid. Interconnected nodes may include, for example, power generators, power transmission and distribution grids, power suppliers, or power consumers associated with an electrical grid. Having some knowledge of interconnected components will aid in determining or predicting localized carbon intensity of electrical grids.

Each interconnected component of the topography of the electrical grid may be associated with a carbon intensity. In an example, power generators using non-renewable sources of energy may be associated with higher carbon intensities than power generators using renewable sources of energy. Power transmissions, e.g., transmission and distribution grids, distributing power based on non-renewable sources of energy may be associated with higher carbon intensities than power transmissions distributing power based on renewable sources of energy. Power suppliers supplying non-renewable sources of energy may be associated with higher carbon intensities than power suppliers using renewable sources of energy. Power consumers relying on non-renewable sources of energy may be associated with higher carbon intensities than power consumers using renewable sources of energy. Power consumers may also consume power through distributed energy resources (DER).

In some embodiments, the one or more sets of data comprises data associated with a carbon intensity of one or more transmission nodes of the first set of nodes or of the second set of nodes. Transmission nodes may include, for example, transmission and distribution grids. Transmission and distribution grids may include, for example, sub-transmission nodes, primary feeder nodes, secondary feeder nodes, or any other components associated with transmission and distribution grids. In some embodiments, the one or more sets of data comprises data associated with a carbon intensity of one or more sub-transmission nodes of the first set of nodes or of the second set of nodes. In some embodiments, the one or more sets of data comprises data associated with a carbon intensity of one or more primary feeder nodes of the first set of nodes or of the second set of nodes. In some embodiments, the one or more sets of data comprises data associated with a carbon intensity of one or more secondary feeder nodes of the first set of nodes or of the second set of nodes. In some embodiments, the one or more sets of data comprises data associated with a carbon intensity of one or more power consumer nodes of the first set of nodes or of the second set of nodes. For example, a power consumer node may be an industrial user, a commercial user, a corporate user, a data center user, or a residential user each associated with a carbon intensity.

In some embodiments, the one or more sets of data comprises data associated with one or more seasonally adjusted parameters of the power generators, power suppliers, or power consumers. In an example, some regions of an electrical grid may be located in areas with high seasonal variation in temperature, rain, snowfall, humidity, or other types of weather affecting power consumption and carbon emissions. Some regions may be located in areas with low seasonal variation in temperature, rain, snowfall, humidity, or other types of weather affecting power consumption and carbon emissions. The high or low seasonal variation may affect supply or demand of electrical power in electrical grids. In some embodiments, the one or more seasonally adjusted parameters associated with the power generators comprises maximum power (Pmax), minimum power (Pmin), heat rates by unit, annual power production levels, or estimates of fuel costs.

In some embodiments, the one or more sets of data comprises data associated with distributed energy resources (DER). In an example, behind-the-meter deployments of clean energy technologies e.g., distributed energy resources, may continue to increase in use and help to achieve reduced carbon emission goals. Distributed energy resources may be included in a determination or prediction of localized carbon intensity. Data related to distribute energy resources may not be readily available and so may be determined using methods for generating a topography described herein elsewhere. In some embodiments, the DER comprises non-renewable power or renewable power. In some embodiments, the DER comprises energy storage. In some embodiments, the energy storage comprises battery storage, thermal storage, mechanical storage, or pumped hydro storage. Distributed energy resources e.g., battery storage may be associated with carbon intensities that change with time due to all the times and magnitudes of power consumption by the battery storage.

Topographies of electrical grids may be viewed as a sparse data set. A data set may be populated using public or private data sets for topographies to determine or predict localized carbon intensity. Public or private data sets may be obtained from public or nonpublic data sources. Alternatively or additionally, methods described herein elsewhere may generate topographies to determine or predict localized carbon intensity. In some embodiments, the one or more data sources comprise one or more public data sources and one or more nonpublic data sources having the one or more sets of data. For example, public data sources may include reporting by public utility companies. Nonpublic data sources may include reports from private companies received by contractual agreement. In some embodiments, the one or more data sources comprise one or more public data sources having the one or more sets of data. In some embodiments, the one or more data sources comprise one or more nonpublic data sources having the one or more sets of data.

Determining or predicting localized carbon intensity (LCI) may be performed by using a trained machine learning (ML) model. In some embodiments, the trained ML model is trained by: (a) receiving one or more sets of data associated with the topography; (b) extracting a first set of linearized parameters from a first set of one or more flows of electrical power of the one or more sets of data; (c) generating a model from the first set of linearized parameters; (d) training the model by analyzing a second set of one or more flows of electrical power to obtain a second set of linearized parameters; and (e) updating the first set of linearized parameters with the second set of linearized parameters to thereby obtain the trained ML model. The one or more sets of data may include partial sets of data having known or unknown parameters and calculations thereof. The one or more sets of data include complete sets of data having known or unknown parameters and calculations thereof. The one more sets of data may include both partial and complete sets of data have known or known parameters and calculations thereof.

Linearized parameters may be associated with one or more flows of electrical power at each node of an electrical grid or between nodes of electrical grids. Linearized parameters may include, for example, real power, reactive power, voltage levels, current levels, phase differences, losses, or any other desired electrical or nonelectrical parameter (e.g., length of transmission lines between nodes) that describes flows of electrical power. Linearized parameters may be used to determine or predict, for example, a contribution or mix of each type of power generator at a node of the electrical grid. The contribution or mix of each type of power generator at a node will aid in determining or predicting localized carbon intensity at each node of the electrical grid.

Linearized parameters may be associated with sensitivity factors. Sensitivity factors may relate the contribution or mix of each type of power generator at one node to another node of an electrical grid or between electrical grids. Sensitivity factors may be associated with each node of an electrical grid. In example, a sensitivity factor of 0.8 may mean that 80% of one type of power generator at a first node is transmitted and received at a second node. The remaining 20% may be transmitted and received at a node other than the second node. Sensitivity factors can be determined using Jacobian matrix methods. Alternatively or additionally, sensitivity factors can be determined through variation of injections of electrical power at nodes and recording of differences in flows of electrical power that occur using steady state analysis of load flow models. In some embodiments, the first set of linearized parameters or the second set of linearized parameters are associated with one or more sensitivity factors. In some embodiments, the one or more sensitivity factors relate the one or more flows of electrical power at a first node of the first set of nodes to a second node at the second set of nodes. In some embodiments, the one or more sensitivity factors comprises a range of about 0 to about 1.

Emissions factors may be associated with power generation, power transmission and distribution grids, power supply, and power consumption. Emission factors may be associated with an amount of carbon dioxide generated or consumed per kilowatt-hour (or megawatt-hour) for each. Emission factors may be associated with carbon intensities. In some embodiments, the one or more emissions factors are associated with one or more non-renewable power generators or one or more renewable power generators. In some embodiments, the one or more emissions factors are associated with one or more non-renewable power generators. In some embodiments, the one or more emissions factors are associated with one or more renewable power generators.

Assigning emission factors to each node of an electrical grid based on the contribution or mix of power at each node provides for determining or predicting localized carbon intensity at each node of the one or more electrical grids. Repeating this for all nodes of the one or more electrical grids provides for determining or predicting localized carbon intensity over markets or regions or over different time scales for the one or more electrical grids. In some embodiments, assigning in (b) further comprises: (a) receiving one or more sets of data associated with the topography having a first set of nodes and a second set of nodes; (b) associating one or more carbon intensities with one or more emissions factors of the first set of nodes or the second set of nodes from the one or more sets of data; and (c) allocating the one or more emissions factors to the first set of nodes or to the second set of nodes thereby assigning the emissions factors.

Behind-the-meter deployments of clean energy technologies e.g., distributed energy resources (DER), may continue to increase in use and help achieve reduced carbon emission goals. Distributed energy resources may include, for example, non-renewable or renewable energy sources. Determining or predicting localized carbon intensity may include effects of distributed energy resources on topographies of electrical grids. Carbon emission effects of distributed energy resources may be accounted for using proportional sharing to determine a contribution or mix of distributed energy resources in relation to other types of non-renewable or renewable energy sources at each node of the one or more electrical grids. For example, generating a topography may reveal that a residential home has a rooftop solar panel having a type, size, or capacity. Proportional sharing principles recognize that some of the power demand may be met by the rooftop solar panel while the remaining demand may be met by power provided through an electrical grid. In some embodiments, the determining in (c) further comprises: (a) determining a presence of one or more non-renewable power generators, renewable power generators, or distributed energy resources (DER) at the first set of nodes or at the second set of nodes; (b) using proportional sharing to determine one or more proportions of one or more carbon intensities of the presence of the non-renewable power generators, the renewable power generators, or the distributed energy resources (DER); and (c) allocating the one or more proportions to the first the of nodes or the second set of nodes thereby determining the one or more carbon intensities.

Determining or predicting localized carbon intensity may require determining or predicting the flow of electrical power at each of node of an electrical grid or between nodes of electrical grids. A flow of electrical power may be associated with a magnitude of electrical power. Magnitude of electrical power may be associated with real power, reactive power, voltage levels, current levels, phase differences, losses, or any other desired electrical parameter to describe flow of electrical power. In some embodiments, the one or more flows of electrical power comprises a magnitude of the one or more flows of electrical power. In some embodiments, the magnitude is associated with one or more power losses in between the first of nodes and the second set of nodes. In some embodiments, the magnitude is associated with one or more voltage potentials between the first of nodes and the second set of nodes. In some embodiments, the magnitude comprises one or more current levels through the first of nodes and the second set of nodes. In some embodiments, the magnitude comprises one or more phase differences in the magnitude between the first set of nodes and the second set of nodes. In some embodiments, the magnitude comprises a real component or a reactive component or both.

Flow of electrical power may change over time due to, for example, changes in supply or demand for electrical power. Flow of electrical power may change over time due to, for example, changes in topographies of electrical grids. A flow of electrical power may be associated with a magnitude of electrical power. Magnitude of electrical power may be associated with real power, reactive power, voltage levels, current levels, phase differences, losses, or any other desired electrical parameter to describe flow of electrical power. In some embodiments, the magnitude changes during a time period from a change in a supply of the electrical power or a change in a demand of the electrical power. In some embodiments, the magnitude changes during the time period from the change in the supply of electrical power. In some embodiments, the magnitude changes during the time period from the change in the demand of electrical power.

Flow of electrical power may be associated with a direction of electrical power between nodes of an electrical grid or between nodes between electrical grids. For example, electrical power may flow in a direction from a node of power generation, through nodes of power transmission, and to a node of power consumption. Power transmission may include transmission and distribution grids. Power losses may be associated with the flow of electrical power due to, for example, losses associated with power generation, power transmission and distribution, power supply, or power consumption. In some embodiments, the one or more flows of electrical power comprises a direction of the one or more flows of electrical power. In some embodiments, the direction comprises a direction between the first set of nodes and the second set of nodes. In some embodiments, the direction is associated with one or more power losses between the first of nodes and the second set of nodes.

Localized carbon intensity may not be static because localized carbon intensity is associated with changes in flows of electrical power. Localized carbon intensity may change over time due to, for example, changes in supply or demand for electrical power. Localized carbon intensity may change over time due to, for example, changes in topographies of electrical grids. Determining or predicting localized carbon intensity may account for the temporal nature of the topography of an electrical grid. In some embodiments, the localized carbon intensity comprises one or more temporal periods for predicting the localized carbon intensity. In some embodiments, the one or more temporal periods is associated with one or more changes in the topography. In some embodiments, the one or more changes comprises a change in one or more supplies of power or one or more demands for power during the one or more temporal periods. In some embodiments, the one or more changes comprises a change from using one or more renewable power generators to using one or more non-renewable power generators during the one or more temporal periods. In some embodiments, the one or more changes comprises a change from using one or more non-renewable power generators to using one or more renewable power generators during the one or more temporal periods. In some embodiments, the one or more changes comprises a change in a number of non-renewable power generators during the one or more temporal periods. In some embodiments, the one or more changes comprises a change in a number of renewable power generators during the one or more temporal periods. In some embodiments, the one or more temporal periods comprises at most about 1 year, 1 month, 1 week, 1 day, 1 hour, 1 minute, or less. In some embodiments, the temporal period comprises at least about 1 minute, 1 hour, 1 day, 1 week, 1 month, 1 year, or more.

Localized carbon intensity may be associated with markets for electricity. Markets may include geographic areas of different size or scope. Markets may include submarkets or regions. Markets may include different topographies of electrical grids. Topographies may include power generation, power transmission or distribution, power supply, or power consumers. In some embodiments, the localized carbon intensity comprises one or more geographic areas for predicting the localized carbon intensity. For example, a geographic area may include a country, a state, a city, a municipality, a region, a district, an industrial center, a commercial center, a residential center, or a combination thereof. In some embodiments, the one or more geographic areas are associated with one or more market areas. For example, market areas may be associated with geographic areas having electrical grids where electrical power is supplied or demanded. In some embodiments, the one or more geographic areas are associated with one or more submarket areas. For example, submarket areas may be associated with market areas or geographic areas having electrical grids where electrical power is supplied or demanded. In some embodiments, the one or more geographic areas associated with one or more producers of the electrical power, one or more purchasers of the electrical power, or one or more consumers of the electrical power. In some embodiments, the one or more geographic areas are located within or outside of one or more market areas. For example, more than one market area may be included in a geographic area. Alternatively or additionally, more than one geographic area may be included in a market area. In some embodiments, the one or more geographic areas are located within the one or more market areas. In some embodiments, the one or more geographics areas are located outside of the one or more market areas.

Localized carbon intensity may be associated with different topographies of electrical grids having carbon emissions from different types of sources. Topographies may include, for example, different types of power generation, power transmission and distribution, power supply, or power consumption having carbon emissions. Different types of power generation may be associated with different carbon emissions. In some embodiments, the topography comprises one or more power generators. In some embodiments, the one or more power generators are associated with the first set of nodes or the second set of nodes. In some embodiments, the one or more power generators are associated with one or more carbon emission sources. In some embodiments, the localized carbon intensity is associated with the one or more carbon emission sources. In some embodiments, the one or more carbon emission sources comprises a quantity of carbon dioxide (CO₂) emitted per megawatt-hour (MWh) produced by the one or more power generators (kg CO₂ eq per MWh). Additionally, carbon emissions may be expressed using any other units according to design preferences.

Different types of power generation may be associated with different carbon emissions. Different types of power generation may include power generators that uses energy sources that are non-renewable, renewable, or a combination of both. In some embodiments, the one or more power generators comprises one or more non-renewable power generators or one or more renewable power generators. Nonlimiting examples of non-renewable power generators may include coal power generators, gas power generators, diesel power generators, propane power generators, or nuclear power generators. In some embodiments, the one or more non-renewable power generators comprises a coal power generator, a gas power generator, or a nuclear power generator. Nonlimiting examples of renewable power generators may include solar power generators, solar mirror power generators, wind power generators, hydropower generators, geothermal power generators, or biomass power generators. In some embodiments, the one or more renewable power generators comprises a solar power generator, a solar mirror power generator, a wind power generator, a hydropower generator, a geothermal power generator, or a biomass power generator.

In some embodiments, the one or more power generators comprises one or more distributed energy resources (DER). In some embodiments, the one or more DER comprises one or more local power generators configured for local use. For example, a residential homeowner may configure roof top solar panels meet some or all of the homeowner's power demand. Nonlimiting examples of distributed energy resources may include roof top solar power, wind power, battery storage power, combined heat and power, biomass power, open and closed cycle gas turbine power, reciprocating engine power, hydro power, fuel cell power, or other generator types. Other generator types may include generators using, for example, diesel fuel, gasoline fuel, propane fuel, or any other suitable fuel. In some embodiments, the one or more local power generators comprises one or more of a roof top solar power, wind power, battery storage power, combined heat and power, biomass power, open and closed cycle gas turbine power, reciprocating engine power, hydro power, fuel cell power, or other generator types. Energy supplied from distributed energy resources may be stored for later used. In some embodiments, the one or more DER comprises one or more local energy storage devices configured for local use. Nonlimiting examples of energy storage may include battery storage devices, thermal storage devices, or mechanical storage devices. In some embodiments, the one or more local energy storage devices comprises one or more battery storage devices, thermal storage devices, or mechanical storage devices. In some embodiments, the one or more DER comprises connecting or disconnecting to the electrical grid. For example, a residential homeowner having roof top solar panels may switch from using the roof top solar panels during the evening and switch to using an electrical grid to meet the homeowner's power demand when there is no sunshine. Alternatively or additionally, the homeowner may connect disconnect from the electrical grid during the evening and connect to a battery storage device to meet the homeowner's power demand when there is no sunshine. In some embodiments, the connecting or disconnecting is based at least on the one or more flows of electrical power.

Topographies may include, for example, different types of power transmission or distribution grids. Nonlimiting examples of transmission and distribution grid components may include electrical lines, poles, transformers, switching and protection circuits, ratings for branches, busbar voltage limits, transformer tap changer characteristics and limits, reactive compensation devices.

Topographies may include, for example, different types of power suppliers. For example, power suppliers may purchase power for supply to electrical grids and transmission to power consumers. Alternatively or additionally, power suppliers may sell power for supply to electrical grids and transmission to power consumers. In some embodiments, the topography comprises one or more power suppliers. Power suppliers may purchase or sell power through contracts or agreements e.g., power purchase agreements. Nonlimiting examples of power suppliers may include private utility companies, public utility companies, cooperatives, or aggregators. In some embodiments, the one or more power suppliers comprises one or more power purchase agreements (PPA), one or more private utility companies, one or more public utility companies, one or more cooperatives, one or more aggregators, one or more energy suppliers, or one or more energy service companies.

Topographies may include, for example, different types of power consumers. In some embodiments, the topography comprises one or more power consumers. In some embodiments, the one or more power consumers are associated with the first set of nodes or the second set of nodes. Nonlimiting examples of power consumers may include industrial users, commercial users, corporate users, data center users, or residential users. In some embodiments, the one or more power consumers comprises one or more of an industrial user, a commercial user, a corporate user, a data center user, or a residential user.

Localized carbon intensity may be provided as one or more reports. For example, reports may be provided to stakeholders from which stakeholders may make decisions concerning planning and operation of electrical grids. Nonlimiting examples of decisions may include, for example, decisions related to generation and consumption of electrical power. Nonlimiting examples of stakeholders may include, for example, the energy industry, energy customers, governments, regulators, communities, corporations, cities, municipalities, or a combination thereof. In some embodiments, the method further comprises providing one or more reports to one or more stakeholders associated with the electrical grid. Nonlimiting examples of reports may include granular information about localized carbon intensity, power generators, power transmission and distribution, power suppliers, power consumers, power supply and demand, or electrical rates. Granular information may be of different geographic or temporal scope as described elsewhere herein. Localized carbon intensity may be provided in reports with a confidence level of the generating or predicting of localized carbon intensity.

Reports providing the generating or predicting of localized carbon intensity may be associated with complete data sets or partial data sets or combination thereof of topographies of electrical grids. For example, partial data sets associated with electrical grids may be available for private companies. Complete data sets associated with electrical grids may be available for public companies. Also, different geographic markets may provide combinations of complete or partial data sets. For example, some countries having geographic markets may report limited data or no data associated with electrical grids. Some countries having geographic markets may report most or all data associated with electrical grids. Having complete data sets or partial data sets may affect confidence levels or accuracy of generating or predicting of localized carbon intensity provided in reports. Confidence levels or accuracy may be improved by methods described herein elsewhere when the generating or predicting of localized carbon intensity is associated with different combinations of complete data sets or partial data sets. Confidence levels or accuracy associated with complete data sets may include generating or predicting localized carbon intensity with at least about 50%, 60%, 70%, 80%, 90%, or better confidence or accuracy. Confidence levels or accuracy associated with partial data sets may include generating or predicting localized carbon intensity with at least about 50%, 60%, 70%, 80%, 90%, or better confidence or accuracy. Confidence levels or accuracy associated with complete data sets or partial data sets may include generating or predicting localized carbon intensity with at least about 50%, 60%, 70%, 80%, 90%, or better confidence or accuracy. In some embodiments, the one or more reports comprises information associated with localized carbon intensity of the one or more stakeholders. Additionally, nonlimiting uses of reports may include providing recommendations about planning and operating electrical grids to reduce localized carbon intensity. Nonlimiting examples of planning or operating may include siting or sizing of components of electrical grids, issuing set-points and control instructions, or inclusion of distributed energy resources in electrical grids. Reports may include providing recommendations about how to reduce localized carbon intensity. In some embodiments, the one or more reports comprises one or more recommendations to reduce the localized carbon intensity of the one or more stakeholders. In some embodiments, the one or more reports comprises sharing the one or more reports with other the one or more stakeholders within the electrical grid. In some embodiments, the one or more reports comprises sharing the one or more reports with other the one or more stakeholders not within the electrical grid.

Localized carbon intensity methods described herein may reduce error in total carbon accounting when compared to other methods. Error may include error in accuracy of total carbon accounting for different geographic and temporal scopes as described elsewhere herein. Other methods may include market-based methods, location-based methods, marginal emissions-based methods, a combination thereof, or any method used for total carbon accounting. Error may be reduced by, for example, at least about 1%, 5%, 10%, 20%, or more. In some embodiments, the method reduces error in predicting the localized carbon intensity compared to other methods. In some embodiments, the other methods average carbon intensities. In some embodiments, the other methods average carbon intensities over a whole market area. In some embodiments, the other methods average carbon intensities over one or more submarkets of a whole market area. In some embodiments, the other methods use marginal carbon emissions.

### Generating a Topography of an Electrical Grid

Localized carbon intensity methods may use or generate topographies of electrical grids. Such methods may use or generate topographies to determine or predict localized carbon intensity with a confidence level or accuracy. Topographies may include a full set of data or a partial set of data. A partial set of data may reduce the accuracy of generating or predicting localized carbon intensity. Accuracy may be improved by methods described herein to generate topographies of electrical grids by determining components of topographies of electrical grids. Nonlimiting examples of components of electrical grids may include components associated with power generators, power transmission and distribution grids, power suppliers, power consumers, distributed energy resources, or any component associated with electrical grids. Components may be associated with nodes of electrical grids as described elsewhere herein.

In another aspect, the present disclosure describes a method for generating a topography of an electrical grid, comprising: (a) receiving data associated with a plurality of components of the electrical grid; (b) determining one or more connections between two or more components of the plurality of components of the electrical grid; (c) associating the one or more connections with a first set of nodes or a second set of nodes of the electrical grid; and (d) determining one or more sensitivity factors between the first of nodes or the second set nodes, thereby generating the topography of the electrical grid.

Generating a topography may include receiving data about components of electrical grids. Data may generally include GIS data associated with any component of any node of electrical grids or between electrical grids. Data may be received through data sources described elsewhere herein. In some embodiments, the data comprises data associated with power generators, power transmissions, power suppliers, or power consumers. For example, power transmissions may include transmission and distribution grids. In some embodiments, the data comprises geographic information system (GIS) data associated with the power generators, power transmissions, power suppliers, or power consumers. For example, a power generator of an electrical grid may be located at a specific geographic location identified by its GIS location.

Data may be received from different data sources including public data sources, nonpublic data sources, or a combination thereof. In some embodiments, the receiving in (a) further comprises receiving the data from one or more data sources. In some embodiments, the one or more data sources comprise one or more public data sources or one or more private data sources.

Data may be received using different modes of data collection. In some embodiments, the one or more data sources comprise one or more satellite sources associated with satellite imagery. For example, satellite imagery of a power generator may be processed to determine the type, size, or capacity of the power generator. Processing may determine that the power generator is a wind farm having 100 wind turbines generating 100 MW of power. In some embodiments, the satellite imagery comprises visible imagery, infrared imagery, or water vapor imagery. For example, infrared imagery may be processed to determine the type, size, or capacity of the power generator. Processing may determine that the power generator is a coal plant having a heat signature correlated to its capacity. In some embodiments, the one or more data sources comprise one or more terrestrial sources associated with terrestrial imagery. For example, terrestrial imagery of a power generator may be processed to determine the type, size, or capacity of the power generator. Processing may determine that the power generator is a rooftop solar panel system having 20 panels generating 20 kW of power. In some embodiments, the terrestrial imagery comprises imagery from driving, pedaling, sailing, or walking around. For example, terrestrial imagery may be obtained from an individual taking a picture of a rooftop solar panel and uploading the picture to a cloud storage system that can later be retrieved.

Generating a topography may include determining connections between components of an electrical grid or between components of electrical grids. Determining connections may include determining proximities between components. In some embodiments, the determining in (b) further comprises processing the data to determine the one or more connections. In some embodiments, the associating in (c) further comprises identifying the one or more connections that are proximate to the first set of nodes or the second set of nodes. For example, a wind farm that is located near a residential community may be connected to and provide power for the residential community. A rooftop solar panel that is located on a residential home may be connected to and provide power for the residential home. A coal plant that is located near an industrial site may be connected to and provide power for the coal plant.

Generating a topography may include generating linearized parameters for each node of an electrical grid or between nodes of electrical grids. Linearized parameters may be associated with one or more flows electrical power between nodes. Sensitivity factors may relate electrical flows of power at one node to electrical flow of power at another node. In some embodiments, the determining in (d) further comprises generating one or more linearized parameters that are associated with the one or more sensitivity factors.

### Uses of Localized Carbon Intensity

As described elsewhere herein, localized carbon intensity methods may determine or predict localized carbon intensity of one or more electrical grids or between one or more electrical grids. Determining or predicting localized carbon intensity may improve efforts to achieve reduced carbon emissions goals in the electricity sector. Localized carbon intensity methods may improve efforts in numerous ways through different use cases. Nonlimiting uses of localized carbon intensity are described herein.

Localized carbon intensity methods may be used to plan and operate electrical grids. For example, electric vehicle (EV) fleets and data centers will continue to grow in use and place additional demands on electrical grids. Localized carbon intensity methods may enable policy makers and legislators to make better decisions related to management of EV fleets or data centers. Better decisions may relate to decisions that reduce carbon emissions associated with EV fleets or data centers when connecting to or disconnecting from electrical grids.

Localized carbon intensity methods may be used to reduce carbon intensity of electrical grids. Providing accurate localized carbon intensity to policy makers and legislators may allow stakeholders to better plan and operate infrastructure, design electrical rates, or implement programs to achieve reduced carbon emissions in electrical grids.

Localized carbon intensity methods may be used to allocate electrical power of electrical grids. Providing accurate localized carbon intensity may help regulators understand the impact that different regions of electrical grids have on carbon emissions. Some regions within electrical grids may have different carbon emissions over a temporal period than other regions within the electrical grids. For example, one region may be an industrial region having substantial electrical power needs during the day. Another region may be a residential region have substantial electrical power needs during the evening. To reduce carbon emissions, regulators may allocate, for example, more renewable sources to the industrial region during the day and allocate more renewable sources to the residential region during the evening. Alternatively or additionally, regulators may allocate, for example, more energy storage devices to the industrial region during the evening and allocate more energy storage devices to the residential region during the day.

Localized carbon intensity methods may be used to adjust a supply and a demand of electrical power of electrical grids. Providing accurate localized carbon intensity may help regulators understand the impact of supply and demand on carbon emissions over a temporal period. Regulators may encourage consumers to shift their electricity demand to different periods of the day when renewable sources are more available or more efficient. For example, a consumer may shift to using renewable sources, e.g., rooftop solar panels, during the day when ample sunshine makes the solar panels more efficient.

Localized carbon intensity methods may be used to determine a rate to charge a user for using electrical power of electrical grids. Providing accurate localized carbon intensity to electricity regulators may help regulators design electrical rates to change behavior of consumers and reduce carbon emissions. For example, regulators may charge a consumer a higher rate to use non-renewable sources to heat the consumer's home and thereby encourage the consumer to consider alternative renewable sources to heat the user's home.

Localized carbon intensity methods may be used to inform a user about the user's carbon emissions associated with use of an electrical grids. Providing accurate localized carbon intensity to consumers of electricity may help consumers understand the impacts of their choices as they relate to use of electrical grids and generation of carbon emissions. For example, a consumer may not understand the impact on carbon emissions when using a non-renewable source to heat the consumer's home. The consumer may consider alternative renewable sources such as rooftop solar powers to heat the consumer's home.

Localized carbon intensity methods may be used to reduce a user's carbon emissions associated with use of an electrical grids. Informed consumers may adjust their behaviors to reduce their carbon emissions. For example, a consumer may decide to install rooftop solar panels to heat the consumer's home.

### System for Predicting a Localized Carbon Intensity

As described elsewhere herein, localized carbon intensity methods may determine or predict localized carbon intensity of one or more electrical grids or between one or more electrical grids. Determining or predicting localized carbon intensity may be performed using a system. The system may include a machine or computing system configured to carry out methods for generating or predicting localized carbon intensity.

In another aspect, the present disclosure provides a system for predicting a localized carbon intensity of an electrical grid, comprising: (a) computer memory storing a topography of the electrical grid; and (b) one or more computer processors operatively coupled to the computer memory, wherein the one or more computer processors are individually or collectively programmed to: i. receive the topography of the electrical grid from the computer memory; ii. assign one or more emissions factors to a first set of nodes or a second set of nodes associated with one or more flows of electrical power through the first set of nodes or the second set of nodes of the topography, wherein the assigning comprises using a trained machine learning (ML) model to determine a power distribution at a node of the first set of nodes or the second set of nodes, wherein the trained ML model has been trained using one or more flows of electrical power through a first set of nodes or a second set of nodes of the topography; and iii. determine one or more carbon intensities from the one or more emissions factors at the first set of nodes or the second set of nodes, thereby predicting the localized carbon intensity of the electrical grid.

### Computing System

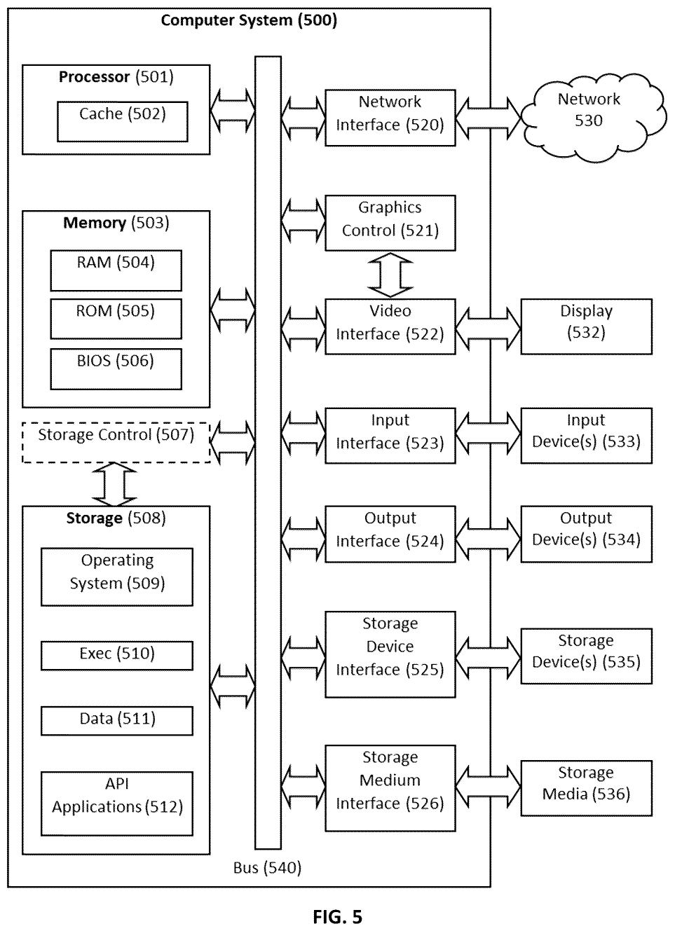

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs) or general purpose graphics processing units (GPGPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display 532. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Select televisions, video players, and digital music players with optional computer network connectivity are suitable for use in the system described herein. Suitable tablet computers, in various embodiments, include those with booklet, slate, and convertible configurations.

In some embodiments, the computing device includes an operating system configured to perform executable instructions. The operating system is, for example, software, including programs and data, which manages the device's hardware and provides services for execution of applications. Suitable server operating systems include, by way of non-limiting examples, FreeBSD, OpenBSD, NetBSDX®, Linux, Apple Mac OS X Server, Oracle®. Solaris®, Windows Server®, and Novell® NetWare®. Suitable personal computer operating systems include, by way of non-limiting examples, Microsoft® Windows®, Apple Mac OS X®, UNIX®, and UNIX-like operating systems such as GNU/Linux®. In some embodiments, the operating system is provided by cloud computing. Suitable mobile smartphone operating systems include, by way of non-limiting examples, Nokia® Symbian® OS, AppleR iOS®, Research In Motion® BlackBerry OSR®, Google® Android®, Microsoft® Windows Phone® OS, Microsoft® Windows Mobile® OS, Linux®, and PalmR WebOS®. Suitable media streaming device operating systems include, by way of non-limiting examples, Apple TV®, Roku®, Boxee®, Google TV®, Google Chromecast®, Amazon Fire®, and Samsung® HomeSync®. Suitable video game console operating systems include, by way of non-limiting examples, Sony® PS3®, Sony® PS4®, Microsoft Xbox 360®, Microsoft Xbox One, Nintendo® Wii®, Nintendo Wii U®, and Ouya®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, a web application, in various embodiments, utilizes one or more software frameworks and one or more database systems. In some embodiments, a web application is created upon a software framework such as Microsoft® .NET or Ruby on Rails® (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. A web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash Actionscript, Javascript®, or Silverlight®. In some embodiments, a web application is written to some extent in a server-side coding language such as Active Server Pages (ASP), ColdFusion, Perl, Java™, JavaServe® Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe Flash®, HTML 5, Apple® QuickTime®, Microsoft Silverlight®, Java™, and Unity®.

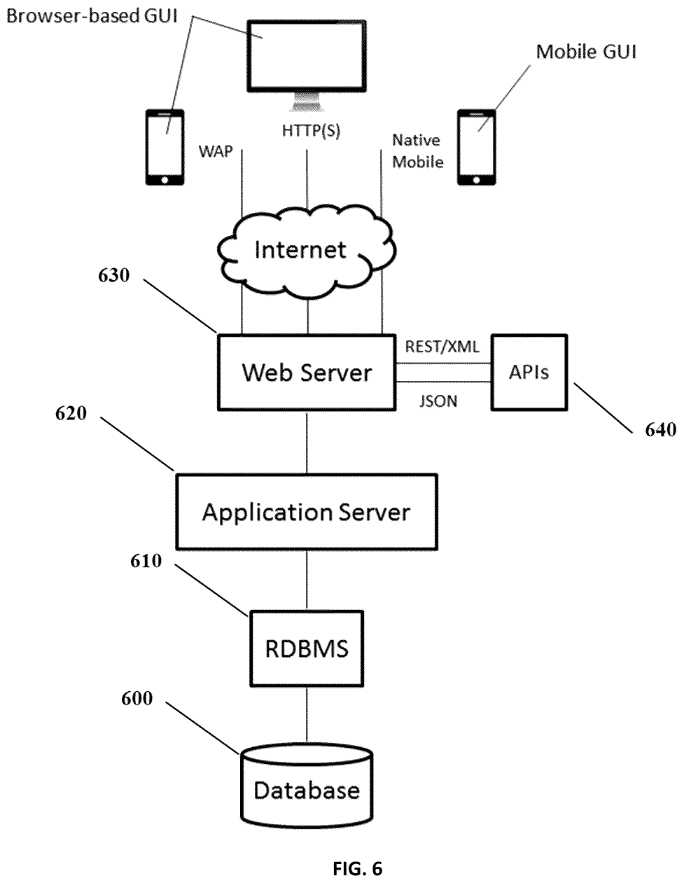

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, SAP Sybase, Teradata, PostGIS, time-series databases, graph databases, and the like. In this embodiment, the application provision system further comprises one or more application severs 620 (such as Java servers, .NET servers, PHP servers, and the like) and one or more web servers 630 (such as Apache, IIS, GWS and the like). The web server(s) optionally expose one or more web services via app application programming interfaces (APIs) 640. Via a network, such as the Internet, the system provides browser-based and/or mobile native user interfaces.

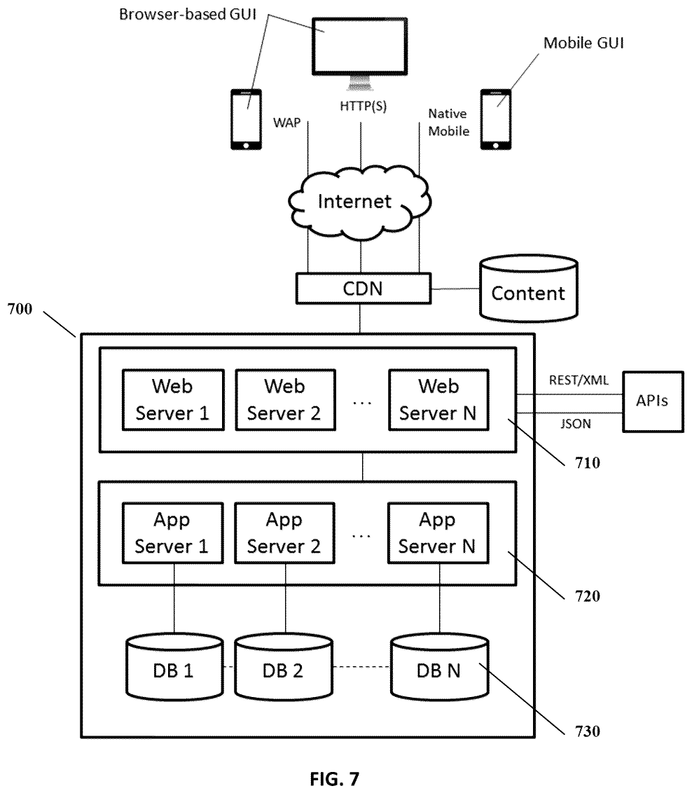

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques using hardware, languages, and development environments. Mobile applications are written in several languages. Suitable programming languages include, by way of non-limiting examples, C, C++, C#, Objective-C, Java™, Javascript®, Pascal, Object Pascal, Python™, Ruby, VB .NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications. Additionally, microservices related to Python™ and JavaScript® may be used.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Several web browser plug-ins may include Adobe® Flash® Player, Microsoft Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft Internet Explorer®, Mozilla Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, GoogleR Android™ browser, RIM BlackBerry® Browser, Apple® Safari®, Palm® Blazer, Palm® WebOS® Browser, Mozilla® Firefox® for mobile, Microsoft® Internet Explorer® Mobile, Amazon Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques using machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, many databases are suitable for storage and retrieval data. In various embodiments, suitable databases include, by way of non-limiting examples, relational databases, non-relational databases, object oriented databases, object databases, entity-relationship model databases, associative databases, XML databases, time-series databases, graph databases, and the like. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In a particular embodiment, a database is a distributed database. In other embodiments, a database is based on one or more local computer storage devices.

### Machine Learning

Many machine learning (ML) methods implemented as algorithms are suitable as approaches to perform the methods described herein. Such methods include but are not limited to supervised learning approaches, unsupervised learning approaches, semi-supervised approaches, or a combination thereof.

Machine learning algorithms may include without limitation neural networks (e.g., artificial neural networks (ANN), multi-layer perceptrons (MLP)), support vector machines, k-nearest neighbors, Gaussian mixture model, Gaussian, naive Bayes, decision trees, or radial basis functions (RBF). Linear machine learning algorithms may include without limitation linear regression, logistic regression, naive Bayes classifier, perceptron, or support vector machines (SVMs). Other machine learning algorithms for use with methods according to the disclosure may include without limitation quadratic classifiers, k-nearest neighbor, boosting, decision trees, random forests, neural networks, pattern recognition, Bayesian networks, or Hidden Markov models. Other machine learning algorithms, including improvements or combinations of any of these, commonly used for machine learning, can also be suitable for use with the methods described herein. Any use of a machine learning algorithm in a workflow can also be suitable for use with the methods described herein. The workflow can include, for example, cross-validation, nested-cross-validation, feature selection, row compression, data transformation, binning, normalization, standardization, and algorithm selection.

A machine learning algorithm can generally be trained by the following methodology:
1. Gather a dataset for “training” and “testing” the machine learning algorithm. The dataset can include many features, for example, type, size, and capacity of power generators. The training dataset is used to “train” the machine learning algorithm. The testing dataset is used to “test” the machine learning algorithm.
2. Determine “features” for the machine learning algorithm to use for training and testing. The accuracy of the machine learning algorithm may depend on how the features are represented. For example, feature values may be transformed using one-hot encoding, binning, standardization, or normalization. Also, not all features in the dataset may be used to train and test the machine learning algorithm. Selection of features may depend on, for example, available computing resources and time or importance of features discovered during iterative testing and training. For example, it may be discovered that features having the type and size of a primary feeder node are predictive of the electrical flow of power being related to a renewable source of energy.
3. Choose an appropriate machine learning algorithm. For example, a machine learning algorithm described elsewhere herein may be chosen. The chosen machine learning algorithm may depend on, for example, available computing resources and time or whether the prediction is continuous or categorical in nature. The machine learning algorithm is used to build the machine learning model.
4. Build the machine learning model. The machine learning algorithm is run on the gathered training dataset. Parameters of the machine learning algorithm may be adjusted by optimizing performance on the testing dataset or via cross-validation datasets. After parameter adjustment and learning, the performance of the machine learning algorithm may be validated on a dataset of naive samples that are separate from the training dataset and testing dataset. The built machine learning model can involve feature coefficients, importance measures, or weightings assigned to individual features.

Once the machine learning model is determined as described above (“trained”), it can be used to make a prediction for localized carbon intensity of electrical grids.

### Terms and Definitions

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### EXAMPLES

The following illustrative examples are representative of embodiments of the platform, software applications, systems, or methods described herein and are not meant to be limiting in any way.

### Example 1-Determining or Predicting Localized Carbon Intensity

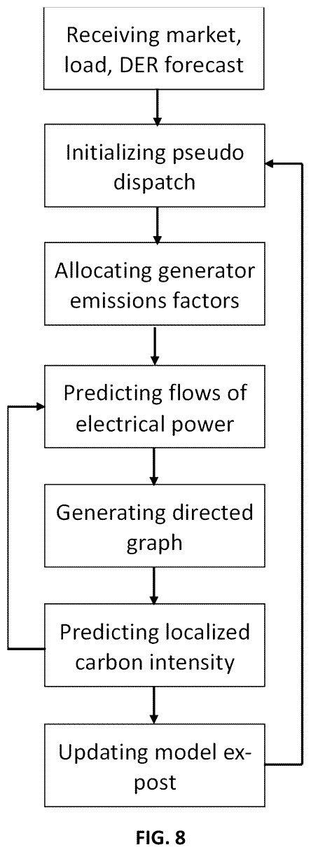

As previously illustrated in FIG. 3, localized carbon intensity methods described herein determine or predict localized carbon intensity of electrical grids by a trained machine learning (ML) model. The trained ML model may determine or predict actual contributions or mix of power generators to meet power demand of power consumers. The determining or predicting may involve understanding flows of electrical power through nodes on electrical grids and associating those flows with linearized parameters, sensitivity factors, and carbon emissions factors. Operations described herein may be performed by the trained ML model to generate or predict localized carbon intensity from flows of electrical power. As illustrated in FIG. 8, operations of the trained ML model may include receiving a market, load, and distributed energy resources (DER) forecast, initializing pseudo dispatch, allocating generator emissions factors, predicting flows of electrical power, generating directed graph, predicting localized carbon intensity, or updating model ex-post. The operations may be iterative with closed loop feedback to update the trained ML model.

### Receiving Market, Load, and DER Forecast

Receiving a market, load, and distributed energy resources forecast may be performed to initialize the model. The receiving of the forecast may be received at a time before the predicting as described elsewhere herein. For example, the forecast may be received a day before the predicting. The forecast may cover a time period, e.g., granularity, before the predicting as describe elsewhere herein. For example, the granularity of the forecast may cover a period of 30 minutes or less. The forecasting may include the day-ahead position across electrical grids over geographic areas or market areas, market demand and price, or location and behavior of distributed energy resources connected to electrical grids. The forecast may include historical data sets of supply and demand and also integrate with a range of platforms used by market operators, public data sources, nonpublic data sources, or technology providers.

### Initializing Pseudo Dispatch

The received market, load, and DER forecast may be used to initialize the model with a pseudo dispatch state to predict market positions for each time step in the day-ahead period. The pseudo dispatch state may further include power generator characteristics. Nonlimiting characteristics may include seasonally adjusted Pₘₐₓ, Pₘᵢₙ, heat rates by unit, annual production values, or region-specific estimates of fuel costs. Market zones having supply and demand “bubbles” can be used to identify contingency scenarios that may require selection and operation of specific generator units in the market dispatch. Contingency scenarios may be generated using unit commitment or security-constrained optimal power flow (SCOPF). Contingency analysis may identify contingencies or unit commitment, and (SCOPF) may aid determinations about contingency scenarios. A contingency scenario approach can also be extended to consider interface flows to surrounding “bubbles” and neighboring market areas. The ML model may be trained using features from the received forecasts and pseudo dispatch. Features may include previous dispatch positions or rolling forecasts based on a broad range of features. From this operation, each generator and load may have an initial state from which to forecast at each time step for the following day.

### Allocating Generator Emissions Factors

Emissions factors may be allocated to or generated for power generators of electrical grids. Governments and market operators may provide different data sets related to emissions factors associated with different types of power generators and also with specific individual generator units. Characteristics specific to the generator unit in question (e.g., a coal plant at a specific location of an electrical grid) may be used. Alternatively or additionally, general characteristics may be used. Also, characteristics may be used that are generated from the methods described herein that generate topographies of electrical grids. From this operation, each generator unit may have a specific emissions factor (kilograms of CO₂ per kWh or MWh) that can be applied to their production for a specific time step.

### Predicting Flows of Electrical Power

Topographies of electrical grids support analysis of electrical flows of power at or through nodes of electrical grids. Analysis can be performed on a fully known topography or on a partially known topography. Alternatively or additionally, a topography may be generated by methods described herein. A more fully described topography may provide better accuracy or confidence in generating or predicting localized carbon intensity. The trained ML model may determine the magnitude and direction of electrical flows of power using a set linearized parameters and sensitivity factors described elsewhere herein. The trained ML model may also predict losses in topographies of electrical grids. From this operation, electrical flows of power having magnitude and direction will be predicted for some or all nodes of topographies of electrical grids. Additionally, this operation along with the ability to converge distribution and transmission power flow models can help inform the appropriate and practical level of granularity for generating or predicting localized carbon intensity.

### Generating Directed Graph

The trained ML model may use the magnitude and direction of flows of electrical power in the form of a decision tree to generate a directed graph of topologies to generate or predict flows of electrical power to and from some or all nodes of topographies electrical grids. The trained ML model may use a constraint or goal such as balancing power supply and demand of electrical grids. Proportional sharing principles may be used by the trained ML model to determine the contribution or mix of multiple paths feeding a node and the allocation of flows to the multiple paths leaving a node. From this operation, each electrical flow of power may be assigned a carbon intensity value (e.g., kilograms of CO₂ equivalent per kWh or MWh) from associated carbon emission factors at each node for a given point in time.

### Predicting Localized Carbon Intensity

In conjunction with the related operations, the trained ML model may include features or contributions of distributed energy resources to meet local demand to determine or predict localized carbon intensity. The model may use, in part, the proportion of the load provided by distributed energy resources and the proportion provided by the electrical grid. From this process, locations of interest may be determined or predicted to have a localized carbon intensity for each time step in the day-ahead forecast. At a granular level, localized carbon intensity can be determined or predicted for a single residential home. At a lesser granular level, localized carbon intensity can be determined or predicted for a country, a state, a city, a municipality, a region, a district, an industrial center, a commercial center.

### Updating Model Ex-Post

The trained ML model may be updated based, in part, on the ending and actual market positions. Also, the trained ML model may be updated based, in part, on the performance of distributed energy resources during the market period. From this process, reports may be provided to stakeholders, as described elsewhere herein, to inform decisions regarding reduced carbon emissions goals or strategies.

While preferred embodiments of the present invention have been shown and described herein, such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions may occur without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-113. (canceled)

114. A method for predicting localized carbon intensity of an electrical grid, comprising:
(a) receiving a topography of the electrical grid;
(b) assigning one or more emissions factors to a first set of nodes or a second set of nodes associated with one or more flows of electrical power through the first set of nodes or the second set of nodes of the topography, wherein the assigning comprises using a trained machine learning (ML) model to determine a power distribution at a node of the first set of nodes or the second set of nodes, wherein the trained ML model has been trained at least in part by using one or more flows of electrical power through a first set of nodes or a second set of nodes of the topography; and
(c) determining one or more carbon intensities from the one or more emissions factors at the first set of nodes or the second set of nodes, thereby predicting the localized carbon intensity of the electrical grid.

115. The method of claim 114, wherein the trained ML model is trained by:
(a) receiving one or more sets of data associated with the topography;
(b) extracting a first set of linearized parameters from a first set of one or more flows of electrical power of the one or more sets of data;
(c) generating a model from the first set of linearized parameters;
(d) training the model by analyzing a second set of one or more flows of electrical power to obtain a second set of linearized parameters; and
(e) updating the first set of linearized parameters with the second set of linearized parameters to thereby obtain the trained ML model.

116. The method of claim 115, wherein the first set of linearized parameters or the second set of linearized parameters are associated with one or more sensitivity factors.

117. The method of claim 116, wherein the one or more sensitivity factors relate the one or more flows of electrical power at a first node of the first set of nodes to a second node of the second set of nodes.

118. The method of claim 117, wherein the one or more sensitivity factors comprise a range of about 0 to about 1.

119. The method of claim 114, wherein the assigning in (b) further comprises:
(a) receiving one or more sets of data associated with the topography having a first set of nodes and a second set of nodes;
(b) associating one or more carbon intensities with one or more emissions factors of the first set of nodes or the second set of nodes from the one or more sets of data; and
(c) allocating the one or more emissions factors to the first set of nodes or to the second set of nodes thereby assigning the emissions factors.

120. The method of claim 119, wherein the one or more emissions factors are associated with one or more non-renewable power generators or one or more renewable power generators.

121. The method of claim 114, wherein the determining in (c) further comprises:
(a) determining a presence of one or more non-renewable power generators, renewable power generators, or distributed energy resources (DER) at the first set of nodes or at the second set of nodes;
(b) using proportional sharing to determine one or more proportions of one or more carbon intensities of the non-renewable power generators, the renewable power generators, or the distributed energy resources (DER); and
(c) allocating the one or more proportions to the first set of nodes or the second set of nodes thereby determining the one or more carbon intensities.

122. The method of claim 114, wherein the one or more flows of electrical power comprise a magnitude of the one or more flows of electrical power.

123. The method of claim 122, wherein the magnitude changes during a time period from a change in a supply of the electrical power or a change in a demand of the electrical power.

124. The method of claim 114, wherein the one or more flows of electrical power comprise a direction of the one or more flows of electrical power.

125. The method of claim 114, wherein the localized carbon intensity comprises one or more temporal periods for predicting the localized carbon intensity.

126. The method of claim 125, wherein the one or more temporal periods are associated with one or more changes in the topography.

127. The method of claim 114, wherein the localized carbon intensity comprises one or more geographic areas for predicting the localized carbon intensity.

128. The method of claim 127, wherein the one or more geographic areas are associated with one or more market areas.

129. The method of claim 127, wherein the one or more geographic areas are associated with one or more submarket areas.

130. The method of claim 127, wherein the one or more geographic areas are associated with one or more producers of the electrical power, one or more purchasers of the electrical power, or one or more consumers of the electrical power.

131. The method of claim 114, wherein one or more power generators are associated with the first set of nodes or the second set of nodes.

132. The method of claim 131, wherein the one or more power generators are associated with one or more carbon emission sources.

133. The method of claim 114, wherein the method further comprises:
(a) receiving one or more reports of actual supply or actual demand of the one or more flows of electrical power;
(b) using the one or more reports to determine one or more actual localized carbon intensities;
(c) comparing the actual localized carbon intensities with one or more predicted localized carbon intensities; and
(d) determining a new set of sensitivity parameters for predicting the localized carbon intensity.
